(19) United States
(12) Patent Application Publication
(10) Pub. No.: US 2008/0114927 A1
(43) Pub. Date: May 15, 2008

(54) SCANNER CONTROLLER

(75) Inventors: Chung-Yi Yao, Taichung (TW); Chien-Huan Wu, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 11/779,909

(22) Filed: Jul. 19, 2007

(30) Foreign Application Priority Data
Nov. 15, 2006 (TW) 95142205

(51) Int. Cl. G06F 12/00

(52) U.S. Cl. 711/105; 711/E12.002

(57) ABSTRACT

A scanner controller includes a cache, a scan manager, and a memory controller. The scanner manager receives image data from an image sensor and caches the image data in the cache. The memory is coupled to a dynamic random access memory (DRAM). When the image data in the cache reaches a predetermined amount, the memory controller outputs a row address strobe (RAS) to activate a row of the DRAM. Two different column address strobes (CAS) are then output to activate columns of the DRAM for moving at least two sets of data from the cache to the DRAM while the row is activated.

### BACKGROUND OF THE INVENTION

1. Field of the Invention

The invention relates to computer techniques, and more particularly to scanner control methods.

2. Description of the Related Art

Document scanning devices require dynamic random access memory (DRAM). The bottleneck in current scanner efficiency lies in bandwidth of the DRAM input/output bus. Thus, improved scanner efficiency may be achieved through more efficient of the input/output bus without requiring additional DRAM.

### BRIEF SUMMARY OF THE INVENTION

Scanner controllers are provided. An exemplary embodiment of a scanner controller packaged in a chip comprises a cache memory, a scan manager, and a memory controller. The scan manager receives image data captured by an image sensor and temporarily stores the image data in the cache memory. The memory controller is coupled to a dynamic random access memory (DRAM). When image data in the cache memory reaches a predetermined amount, a row address strobe activates a row in the DRAM, and at least two distinct column address strobes activate columns in the DRAM while the row is activated. Thus, at least two subsets of the image data are transmitted to the DRAM.

An exemplary embodiment of a scanner controller packaged in a chip comprises a cache memory and a memory controller. The memory controller coupled to a dynamic random access memory (DRAM), when reading image data in the DRAM captured by an image sensor delivers a row address strobe to activate a row in the DRAM. At least two distinct column address strobes activate columns in the DRAM while the row is activated. Thus, at least two subsets of the image data are read from the DRAM for transmission to the cache memory.

An exemplary embodiment of a scanner controller is packaged in a chip. The scanner controller comprises a cache memory and a memory controller.

The scan manager receives image data captured by an image sensor and temporarily stores the image data in the cache memory. A memory controller coupled to a random access memory (RAM), when the image data in the cache memory reaches a predetermined amount, transmits the image data to the RAM. The predetermined amount of image data comprises the amount of data supportable by two RAM writing operations.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary embodiment of a document scanner; and

FIG. 2 is a flowchart showing an exemplary embodiment of data transfer from a cache memory to a DRAM; and

FIG. 3 is a flowchart showing another exemplary embodiment of data transfer from a cache memory to a DRAM.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

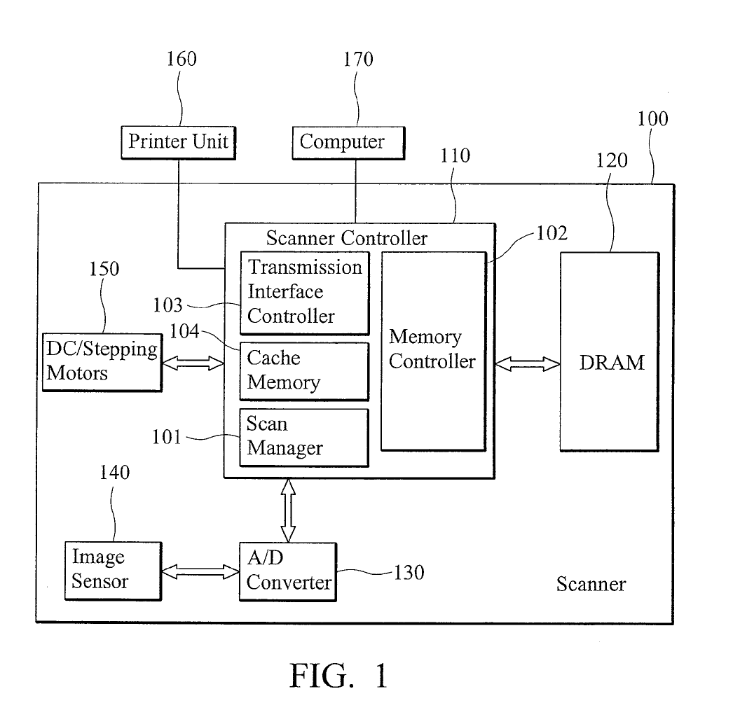

Various exemplary embodiments of scanner controllers of the invention are provided in the following. With reference to FIG. 1, scanner 100 may be coupled to a computer 170 and a printer unit 160. Scanner controller 110 comprises scan manager 101, memory controller 102, transmission interface controller 103 and cache 104. Scanner controller 110 may be packaged as a chip.

Scan manager 101 conducts DC/stepping motors 150 and image sensor 140 to scan. Image sensor 140 captures image data. Scan manager 101 receives image data which has been converted to digital by analog-to-digital converter (A/D converter) 130 and temporarily stores the same in cache memory 104.

Memory controller 102 directs data transfer between cache memory 104 and DRAM 120. Transmission interface controller 103 outputs image data, such as to computer 170 or printer unit 160 for printing. Cache memory 104 may be made from static random access memory (SRAM).

DRAM 120 may comprise extended data out random access memory (EDO RAM), dynamic random access memory (DRAM), synchronous dynamic random access memory (SDRAM), double data rate SDRAM (DDR SDRAM), double data rate 2 SDRAM (DDR2 SDRAM), or other memory types.

The sensor array of image sensor 140 may be a charge-coupled device (CCD), contact image sensor (CIS), or complementary metal-oxide semiconductor (CMOS). The sensor array of image sensor 140 may be arranged in a line for sensing light and accordingly generating image data. A/D converter 130 converts image data from analog to digital.

In some embodiments, a scanner and a printer may be combined in a single device, such as a multifunction device (MFD), copier, or FAX machine.

First, scan manager 101 generates control clocks to image sensor 140, DC/stepping motor 150, and A/D converter 130. When receiving the control clocks, image sensor 140 outputs analog pixel signals generated from the sensor array to A/D converter 130. A/D converter 130 converts analog pixel signals to digital pixel signals and transmits the digital pixel signals as image data to scan manager 101.

When receiving image data, scan manager 101 processes and stores the image data (referred to as image preprocessing) in cache memory 104. When image data in cache memory 104 reaches a predetermined amount, memory controller 102 may automatically move image data from cache memory 104 to DRAM 120 and record the data in DRAM 120.

Specifically, during image data transmission, when image data received by scan manager 101 reaches a predetermined amount, memory controller 102 begins to transmit the image data to DRAM 120. The predetermined amount may be greater than or equal to the amount of data supportable by two writing operations of DRAM 120. Data carried by a reading or writing operation in burst mode of DRAM 120 is referred to as a burst. Two examples are given in the following.

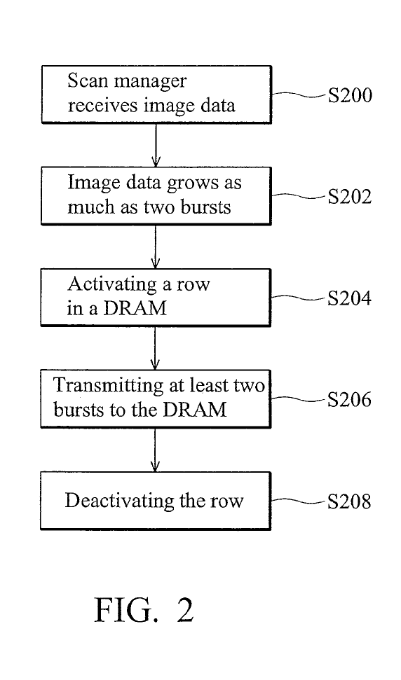

The capacity of cache memory 104, for example, comprises at least the same bits of two bursts of the burst mode of DRAM 120. With reference to FIG. 2, scan manager 101 receives image data (step S200). When image data in cache memory 104 reaches two bursts (step S202), memory controller 102 transmits a row address strobe to activate a row of memory cells in DRAM 120 (step S204). While the row is activated, at least two different column address strobes are transmitted to DRAM 120 to send at least two bursts of image data in cache memory 104 to DRAM 120 (step S206). After data transmission is complete, memory controller 102 closes the row (step S208).

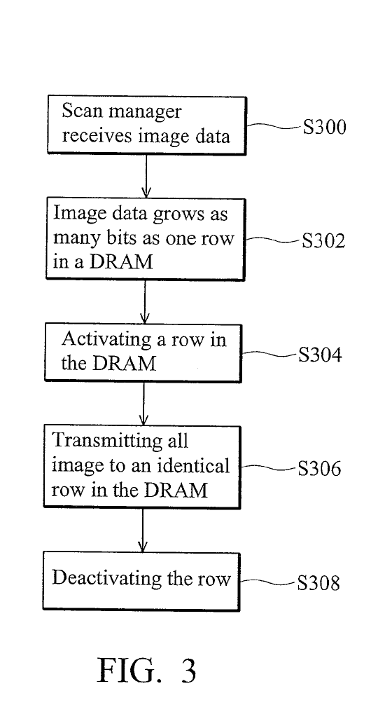

Alternatively, the capacity of cache memory 104 may comprise at least the same or a multiple of bits of one row of DRAM 120. With reference to FIG. 3, scan manager 101 receives image data (step S300). When image data in cache memory 104 reaches the same number of bits in one row of DRAM 120 (step S302), memory controller 102 transmits a row address strobe to activate a row in DRAM 120 (step S304). While the row is activated, at least two different column address strobes to DRAM 120 are transmitted to send all of the image data in cache memory 104 to one row of DRAM 120 (step S306). After completing data transmission, memory controller 102 closes the row (step S308).

When the amount of image data stored in DRAM 120 reaches twice as much as the number of pixels in the sensor array of image sensor 140, scan manager 101 directs memory controller 102 to retrieve and transmit image data from DRAM 120 to scan manager 101 for a second stage of image processing.

When being to read image data from DRAM 120, memory controller 102 transmits a row address strobe to activate a row in DRAM 120, and while the row is activated, at least two different column address strobes are transmitted to DRAM 120 to read at least two bursts of image data from DRAM 120 to cache memory 104. Alternatively, while the row is activated, memory controller 102 may transmit different column address strobes to read all image data in the row of DRAM 120 to cache memory 104.

Scan manager 101 receives and processes (referred to as post image processing) the image data, and stores the processed image data in cache memory 104. In response to storage of the processed image data in cache memory 104, transmission interface controller 103 reads and transmits the image data therefrom to printer unit 160 for printing or to computer 170 for storage.

A scanner of the invention, such as scanner 100, may be integrated into a flatbed scanner, multifunction device (MFD), copier, or FAX machine.

Rather than directly transmitting image data received by scan manager 101 to DRAM 120, scanner 100 does not transmit the image data from cache memory 104 to DRAM 120 until the amount of data reaches a predetermined level.

A scanner of the invention, such as scanner 100, utilizes integrated circuits (IC) to transmit data. For any row of DRAM 120, datasets thereon are carried as an entire row or successive bursts between DRAM 120 and cache memory 104, thus eliminating operations for switching between rows in DRAM 120, efficiently utilizing the data bus in DRAM 120, and enhancing access efficiency of DRAM 120.

In conclusion, adequate cache memory for temporary data storage is built into a scanner controller IC. Additionally, a data transmission protocol therein is modified to improve scanning speed of document scanning devices. Scanning efficiency can be improved without by embedding adequate cache memory in a scanner controller IC.

Because DRAM access efficiency is improved, scanning devices may be equipped with a single DRAM chip rather than multiple DRAM chips connected in parallel, thus, material cost can be significantly reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner controller, packaged in a chip, comprising:
a cache memory;
a scan manager receiving image data captured by an image sensor and temporarily storing the image data in the cache memory;
a memory controller coupled to a dynamic random access memory (DRAM), when the image data in the cache memory reaches a predetermined amount, delivering a row address strobe to activate a row in the DRAM, and at least two distinct column address strobes to activate columns in the DRAM while the row is activated, thus transmitting at least two subsets of the image data to the DRAM.

2. The controller as claimed in claim 1, wherein the cache memory comprises memory capacity adequate to accommodate at least two bursts utilized in the burst mode of the DRAM, and each of the two subsets comprises a burst.

3. The controller as claimed in claim 1, wherein the cache memory comprises memory capacity adequate to accommodate a least one row of the DRAM.

4. The controller as claimed in claim 3, wherein image data in the cache memory reaches the same number of bits as one row of the DRAM, the memory controller begins to transmit all image data from the cache memory to the DRAM.

5. The controller as claimed in claim 1, wherein the scanner controller, the DRAM, and the image sensor comprise a multifunction machine, a copier, a fax device, or a scanner.

6. The controller as claimed in claim 1, wherein the DRAM comprise an EDO RAM, SDRAM, DDR SDRAM, or DDR2 SDRAM.

7. A scanner controller, packaged in a chip, comprising:
a cache memory;
a memory controller coupled to a dynamic random access memory (DRAM), when reading image data in the DRAM captured by an image sensor, delivering a row address strobe to activate a row in the DRAM, and at least two distinct column address strobes to activate columns in the DRAM while the row is activated, thus at least two subsets of the image data are read from the DRAM for transmission to the cache memory.

8. The controller as claimed in claim 7, wherein the cache memory comprises memory capacity adequate to accommodate at least two bursts utilized in the burst mode of the DRAM, and each of the two subsets comprises a burst.

9. The controller as claimed in claim 7, wherein the cache memory comprises memory capacity adequate to accommodate a least one row of the DRAM.

10. The controller as claimed in claim 9, wherein when the row is activated, the memory controller reads data in the row for transmission to the cache memory.

11. The controller as claimed in claim 7, wherein the scanner controller, the DRAM, and the image sensor comprise a multifunction machine, a copier, a fax device, or a scanner.

12. The controller as claimed in claim 7, wherein the DRAM comprises an EDO RAM, SDRAM, DDR SDRAM, or DDR2 SDRAM.

13. The controller as claimed in claim 7, furthers comprises:
a transmission interface controller transmitting image data from the cache memory to a computer coupled to the scanner controller.

14. The controller as claimed in claim 7, further comprise:
a printer for document printing; and
a transmission interface controller transmitting image data from the cache memory to the printer for printing.

15. A scanner controller, packaged in a chip, comprising:
a cache memory;
a scan manager receiving image data captured by an image sensor and temporarily storing the image data in the cache memory;
a memory controller coupled to a dynamic random access memory (DRAM), when the image data in the cache memory reaches a predetermined amount, transmitting the image data to the DRAM, wherein the predetermined amount comprises the amount of data supportable by two writing operations of the DRAM.

16. The controller as claimed in claim 15, wherein the predetermined amount is equal to at least two bursts utilized in the burst mode of the DRAM.

17. The controller as claimed in claim 15, wherein the predetermined amount is equal to the bits of at least one row of the DRAM.

18. The controller as claimed in claim 17, wherein when image data received by the scan manager reaches the same number of bits as one row of the DRAM, the memory controller begins to transmit all image data from the cache memory to the DRAM.

19. The controller as claimed in claim 15, wherein the scanner controller, the DRAM, and the image sensor comprise a multifunction machine, a copier, a fax device, or a scanner.

20. The controller as claimed in claim 15, wherein the DRAM comprises a EDO RAM, SDRAM, DDR SDRAM, or DDR2 SDRAM.
